(19) United States
(12) Patent Application Publication
(10) Pub. No.: US 2008/0244857 A1
(43) Pub. Date: Oct. 9, 2008

(54) Windscreen Wiper Drive Arm Comprising An Elastically Deformable Section Flexurally Rigidified In A Plane By Inextensible Reinforcing Elements

(75) Inventor: Philippe Espinasse, Coudes (FR)

Correspondence Address: OSHA LIANG L.L.P., 1221 MCKINNEY STREET, SUITE 2800, HOUSTON, TX, 77010, US

(73) Assignee: VALEO SYSTEMES D'ESSUYAGE, Le Mesnil-Saint-Denis (FR)

(21) Appl. No.: 12/067,643

(22) PCT Filed: Sep. 20, 2006
(86) PCT No.: PCT/EP2006/009146

§ 371 Date: Jun. 19, 2008

(30) Foreign Application Priority Data
Sep. 21, 2005 (FR) 0509613

(51) Int. Cl. B60S 1/32

(52) U.S. Cl. 15/250.46

(57) ABSTRACT

A drive arm for a wiper blade has a rear end portion configured to be fixed to a drive shaft of the arm in an alternating sweep movement about a roughly vertical axis, a free front end portion operable to carry the wiper blade, an intermediate portion of longitudinal principal orientation that is elastically deformable in a vertical longitudinal plane and that connects the rear portion to the front portion, and a stiffener for stiffening the intermediate portion flexurally in a horizontal plane. The stiffener has at least one first flexible longitudinal element that is fixed along a first longitudinal lateral face of the intermediate portion so that, when a transverse force is applied to the intermediate portion in a first direction, a longitudinal stress is exerted on the first reinforcing element.

The invention concerns a drive arm of a wiper blade that comprises an intermediate portion of longitudinal principal orientation that is elastically deformable in a vertical longitudinal plane.

The invention comprises more particularly a drive arm for a wiper blade that comprises:
a rear end portion that is intended to be fixed to a drive shaft of the arm in an alternating sweep movement about a roughly vertical axis;
a free front end portion that is able to carry the wiper blade;
an intermediate portion of longitudinal principal orientation that is elastically deformable in a vertical longitudinal plane and that connects the rear portion to the front portion, and
a stiffener for stiffening the intermediate portion flexurally in a horizontal plane.

The document FR-A-2.515.121 describes such a drive arm for which the central web of the intermediate portion is produced from composite material based on glass fibres, and for which an external sheath surrounds the entire central web and is produced from composite material based on carbon fibres that are oriented at approximately 45° with respect to the longitudinal direction.

The central core is thus elastically deformable flexurally, while the sheath increases the torsional rigidity of the arm about its longitudinal principal axis, in comparison with a conventional arm whose structure is metal.

The flexibility of the arm in a vertical longitudinal plane in particular enables the arm to exert a vertical elastic return force in order to press the wiper blade against a facing glazed surface, but also enables an operator to replace the wiper blade by gripping the free front end portion of the drive arm in order to move it away from the glazed surface.

However, when the drive arm is mounted on a vehicle and is driven in alternating sweep, the rubbing of the wiper blade against the window exerts a horizontal transverse force on the free end of the wiper blade. This force is liable to make the intermediate portion flex in a horizontal plane. There is a risk that the quality of the wiping may then suffer because of this.

To avoid this inconvenience, it is known how to conform the drive arm so as to stiffen the intermediate portion flexurally in a horizontal plane, while the intermediate portion keeps great flexibility in a vertical longitudinal plane. For this purpose, it is known how to design the intermediate portion with a “small” transverse width compared with its thickness.

However, such a drive arm is not yet sufficiently rigid flexurally in a horizontal plane. In addition, in order to improve further the rigidity of the drive arm, it is necessary to broaden the arm even further, which is expensive and not very aesthetic.

To remedy this problem, the invention proposes a drive arm of the type described previously, characterised in that the stiffener comprises at least one first flexible longitudinal element that is fixed along a first longitudinal lateral face of the intermediate portion so that, when a transverse force is applied to the intermediate portion in a first direction, a longitudinal stress is exerted on the first reinforcing element, the first reinforcing element being non-deformable longitudinally in the direction of the stress so as to limit the flexion of the intermediate portion in a horizontal plane in the first direction.

According to other characteristics of the invention:
the stiffener comprises a second flexible longitudinal element that is fixed along a second longitudinal lateral face of the intermediate portion so that, when a transverse force is applied to the intermediate portion in a second direction, a longitudinal stress is exerted on the second reinforcing element, the second reinforcing element being non-deformable longitudinally in the direction of the stress so as to limit the flexion of the intermediate portion in a horizontal plane in a second direction;
the transverse force exerts a traction tension on the reinforcing element, and the reinforcing element is longitudinally inextensible;
the transverse force exerts a compression stress on the reinforcing element, and the reinforcing element is longitudinally non-compressible;
the two elements of the stiffener are arranged in the same horizontal plane as the neutral fibre of the intermediate portion;
each reinforcing element comprises at least one longitudinal reinforcing length that is formed from unidirectional fibres;
the reinforcing lengths comprise so-called “high modulus of elasticity” carbon fibres, which are oriented longitudinally;
the intermediate portion comprises a longitudinal web elastically deformable flexurally in all directions;
the web is covered with at least one surface sheath that is able to increase the torsional stiffness of the intermediate portion about its longitudinal principal axis;
the surface sheath covers the lateral reinforcing elements;
the longitudinal element or elements of the stiffener are fixed to the external surface of the surface sheath.

Other characteristics and advantages will emerge during the following detailed description, for an understanding of which reference should be made to the accompanying drawings, among which:

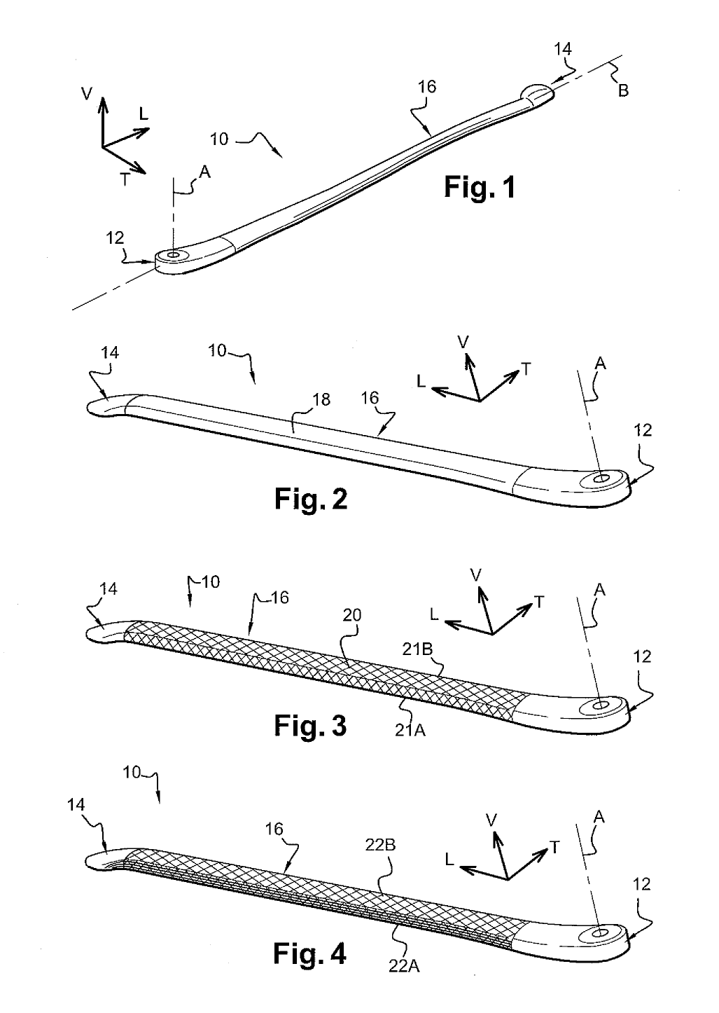

FIG. 1 is a partial view in perspective that depicts a drive arm comprising a flexible intermediate portion;

FIG. 2 is a view in perspective that depicts the web of the flexible portion of the drive arm of FIG. 1;

FIG. 3 is a view similar to that of FIG. 2 that depicts the web of the flexible portion of FIG. 2 that is covered with a sheath;

FIG. 4 is a view similar to the one in FIG. 3 in which the flexible portion comprises reinforcement elements produced according to the invention in order to stiffen the drive arm flexurally in a horizontal plane;

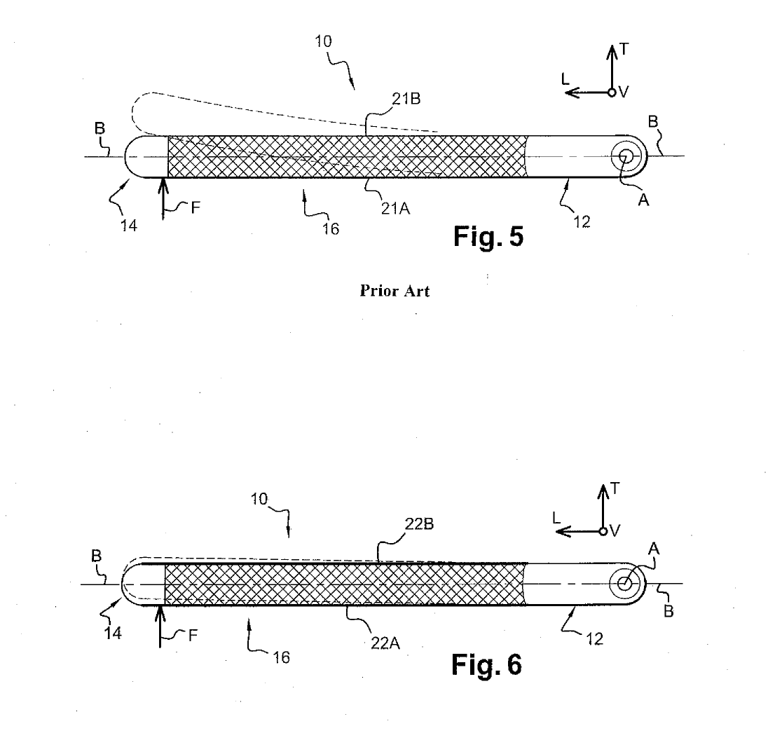

FIG. 5 is a plan view that depicts a drive arm comprising a flexible portion that is produced according to the prior art;

FIG. 6 is a plan view that depicts a drive arm comprising a flexible portion that is produced according to the teachings of the invention.

For the remainder of the description, a longitudinal, vertical and transverse orientation indicated by the trihedron L,V,T in the figures will be adopted non-limitatively.

The longitudinal direction is oriented from rear to front in the direction of the arrow “L” in the figures.

Subsequently, identical, analogous or similar elements will be indicated by the same reference numbers.

FIG. 1 depicts a drive arm 10 of a wiper blade (not shown) in alternating sweep with respect to a roughly horizontal glazed surface (not shown), about a vertical axis “A”.

The drive arm 10 has a longitudinally oriented principal axis “B” and comprises a rear end portion 12 by means of which the drive arm 10 is fixed to a drive shaft (not shown) of the arm 10 in alternating sweep about the vertical axis “A”. The drive arm 10 comprises a free front end portion 14 that is conformed so as to allow the mounting of the wiper blade on the drive arm 10.

The drive arm 10 also comprises an intermediate portion 16 of axis “B”, of longitudinal principal orientation, that connects the rear portion 12 to the front portion 14. This intermediate portion 16 is elastically deformable flexurally in a vertical longitudinal plane.

As can be seen in more detail in FIGS. 2 to 4, the intermediate portion is here produced from composite material.

As depicted in FIG. 2, it comprises in particular a web 18 of longitudinal principal orientation that consists of a material elastically deformable flexurally in all directions. The web 12 is for example formed from epoxy resin containing glass fibres that are short compared with the longitudinal length of the intermediate portion 16. The glass fibres are oriented randomly so that the material making up the web 18 is isotropic. The web 18 comprises for example 10% glass fibres by volume. Such a web has a modulus of elasticity, or Young's modulus, of low value, for example around

10 GPa.

The web 18 is conformed so as to favour the elastic deformation of the intermediate portion 16 flexurally in a vertical longitudinal plane and reduce the elastic deformation of the intermediate portion 16 flexurally in a longitudinal transverse plane. Thus the web 18 has a transverse width that is greater than its vertical thickness.

As shown in FIG. 3, the web 18 is covered with a surface sheath 20 that is able to increase the stiffness of the intermediate portion 16 torsionally about its longitudinal principal axis. The sheath 20 is here formed from a fabric that comprises long fibres that extend helically all along the intermediate portion 16 about the longitudinal principal axis. The fibres are oriented so as to form an angle of approximately 45° with respect to the longitudinal orientation “L”. The fabric 20 is thus draped all around the web 18. It is for example a glass fabric woven with glass fibres.

The fabric 20 is chosen so as not to substantially stiffen the intermediate portion 16 flexurally.

In this way a drive arm 10 produced according to the prior art is obtained.

As illustrated in FIG. 5, when a transverse force “F” is applied to the front portion 14 of this drive arm 10, the intermediate portion 16 flexes in a horizontal plane, as shown in broken lines. The neutral fibre, that is to say the material that is situated in the vicinity of the central principal longitudinal axis of the intermediate portion 16, flexes without changing length and without undergoing any traction or compression stress. On the other hand, the material constituting a first lateral face 21A, shown at the bottom in FIG. 5, is subjected to a traction tension that extends it, while the material constituting the second lateral face 21B, as shown at the top in FIG. 5, is subjected to a longitudinal compression force that shortens it.

According to the teachings of the invention, in order to resolve this problem, the drive arm 10 comprises a stiffener for increasing the stiffness of the intermediate portion 16 flexurally in a horizontal plane.

As shown in FIG. 4, the stiffener comprises a first longitudinal reinforcing length 22A and a second longitudinal reinforcing length 22B that are flexible. Each of the reinforcing lengths 22A, 22B is fixed along a lateral face 21A, 21B, longitudinal and vertical, associated with the intermediate portion 16. Each reinforcing length 22A, 22B is tensioned along the associated lateral face 21A, 21B of the intermediate portion 16. Advantageously, the reinforcing length 22A, 22B is fixed all along its length against the associated lateral face 21A, 21B, for example by bonding with resin.

Each reinforcing length 22A, 22B, is substantially inextensible in longitudinal traction, that it to say each length has a very high modulus of longitudinal elasticity compared with the modulus of elasticity of the web 18, for example greater than 400 GPa. Thus, if a traction force is applied to a reinforcing length 22A, 22B, the latter will not extend, or only negligibly. The reinforcing lengths 22A, 225 here consist of longitudinal unidirectional fibres, for example carbon fibres with a so-called “high modulus of elasticity”.

The two reinforcing lengths 22A, 22B are fixed in the same horizontal plane as the neutral fibre “B” of the intermediate portion 16.

The two reinforcing lengths 22A, 22B are here arranged against the external surface of the surface sheath 20. According to a variant that is not shown, the reinforcing lengths 22A, 22B are arranged against the web 18 of the intermediate portion 16 and are then covered by the surface fabric 20.

As can be seen in FIG. 6, when the drive arm 10 is equipped with reinforcing lengths 22A, 22B produced according to the teachings of the invention, the transverse force “F” induces a traction tension in the first reinforcing length 22A associated with the first face. However, the first reinforcing length 22A is inextensible, that is to say it does not extend. Thus the intermediate portion 16 does not flex in the horizontal plane, or only negligibly, the deformation being contained by the first reinforcing length 22A.

If the transverse force “F” is applied in the other direction, it is the second reinforcing length 22B that is acted on in traction. In the same way, the intermediate portion 16 does not flex, or only negligibly.

On the other hand, when a vertical force (not shown) is applied to the front end portion 14, the reinforcing lengths 22A, 22B are not acted on in traction, since they are arranged in the same horizontal plane as the neutral fibre “B” of the intermediate portion 16. The reinforcing lengths 22A, 22B being flexible flexurally, they therefore do not stiffen the intermediate portion 16 flexurally in a vertical horizontal plane.

According to another embodiment that can be combined with the embodiment described previously, the flexible reinforcing lengths 22A, 22B are formed from a longitudinally non-compressible material so as to prevent the flexion of the intermediate portion 16 in a horizontal plane.

In this case, as shown in FIG. 6, the force “F” applied transversely induces a compression stress in the second reinforcing length 22B. However, the reinforcing length 22B being non-compressible, it prevents the intermediate portion 16 from flexing in the horizontal plane.

According to another variant of the invention, not shown, the stiffener comprises only one longitudinal element 22 that is associated with only one of the lateral faces 21A, 21B of the intermediate portion 16. This longitudinal element 22 is flexible, longitudinally non-compressible and longitudinally inextensible. Thus this single longitudinal element 22 suffices to prevent the intermediate portion 16 from flexing in a first direction since it is non-compressible, and in a second direction since it is inextensible.

The invention has been described with reference to a composite arm composed of a web 18, a sheath 20 and lateral reinforcing lengths 22A, 22B, each material thus fulfilling a distinct single function. The web 18 confers on the intermediate portion 18 its flexibility, the sheath 20 confers on the intermediate portion 16 its torsional rigidity, and the reinforcing lengths 22A, 22B confer on the intermediate portion its flexural rigidity in a horizontal plane.

However, the invention is also applicable to a drive arm 10 in which the intermediate portion 16 has similar mechanical properties but a different structure.

1. A drive arm for a wiper blade comprising:
a rear end portion configured to be fixed to a drive shaft of the arm in an alternating sweep movement about a roughly vertical axis;
a free front end portion operable to carry the wiper blade;
an intermediate portion of longitudinal principal orientation that is elastically deformable in a vertical longitudinal plane and that connects the rear portion to the front portion, and
a stiffener for stiffening the intermediate portion flexurally in a horizontal plane,
wherein the stiffener comprises at least one first flexible longitudinal element that is fixed along a first longitudinal lateral face of the intermediate portion so that, when a transverse force is applied to the intermediate portion in a first direction, a longitudinal stress is exerted on the first reinforcing element, and
wherein the first reinforcing element is non-deformable longitudinally in the direction of the stress so as to limit the flexion of the intermediate portion in a horizontal plane in the first direction.

2. A The drive arm according to claim 1, wherein the stiffener comprises a second flexible longitudinal element that is fixed along a second longitudinal lateral face of the intermediate portion so that, when a transverse force is applied to the intermediate portion in a second direction, a longitudinal stress is exerted on the second reinforcing element, and wherein the second reinforcing element is non-deformable longitudinally in the direction of the stress so as to limit the flexion of the intermediate portion in a horizontal plane in a second direction.

3. The drive arm according to claim 1, wherein the transverse force exerts a traction tension on the reinforcing element, and wherein the reinforcing element is longitudinally inextensible.

4. The drive arm according to claim 1, wherein the transverse force exerts a compression stress on the reinforcing element, and wherein the reinforcing element is longitudinally non-compressible.

5. The drive arm according to claim 4, wherein the two elements of the stiffener are arranged in the same horizontal plane as the neutral fibre of the intermediate portion.

6. The drive arm according to claim 1, wherein each reinforcing element comprises at least one longitudinal reinforcing length that is formed from unidirectional fibres.

7. The drive arm according to claim 6, wherein the reinforcing lengths comprise high modulus of elasticity carbon fibres oriented longitudinally.

8. The drive arm according to claim 1, wherein the intermediate portion comprises a longitudinal web elastically deformable flexurally in all directions.

9. The drive arm according claim 8, wherein the web is covered with at least one surface sheath that is able to increase a torsional stiffness of the intermediate portion about its longitudinal principal axis.

10. The drive arm according to claim 9, wherein the surface sheath covers the lateral reinforcing elements.

11. The drive arm according to claim 9, wherein the longitudinal element of the stiffener is fixed to the external surface of the surface sheath.

12. The drive arm according to claim 2, wherein the transverse force exerts a traction tension on the reinforcing element, and wherein the reinforcing element is longitudinally inextensible.

13. The drive arm according to claim 2, wherein the transverse force exerts a compression stress on the reinforcing element, and wherein the reinforcing element is longitudinally non-compressible.

14. The drive arm according to claim 13, wherein the transverse force exerts a compression stress on the reinforcing element, and wherein the reinforcing element is longitudinally non-compressible.

15. The drive arm according to claim 2, wherein each reinforcing element comprises at least one longitudinal reinforcing length that is formed from unidirectional fibres.

16. The drive arm according to claim 3, wherein each reinforcing element comprises at least one longitudinal reinforcing length that is formed from unidirectional fibres.

17. The drive arm according to claim 4, wherein each reinforcing element comprises at least one longitudinal reinforcing length that is formed from unidirectional fibres.

18. The drive arm according to claim 5, wherein each reinforcing element comprises at least one longitudinal reinforcing length that is formed from unidirectional fibres.

19. Sew) The drive arm according to claim 12, wherein each reinforcing element comprises at least one longitudinal reinforcing length that is formed from unidirectional fibres.

20. The drive arm according to claim 13, wherein each reinforcing element comprises at least one longitudinal reinforcing length that is formed from unidirectional fibres.
